(19) United States
(12) Patent Application Publication
(10) Pub. No.: US 2017/0022107 A1
(43) Pub. Date: Jan. 26, 2017

(54) SYNTHESIS AND APPLICATION OF CaSO4-BASED HARDENING ACCELERATORS

(71) Applicant: BASF SE, Ludwigshafen (DE)

(72) Inventors: Max SIEBERT, Ludwigshafen (DE); Andreas KEMPTER, Neustadt (DE); Christoph HESSE, Ebersberg (DE); Niklas LOGES, Pittenhart (DE); Rebecca SCHMITT, Ludwigshafen (DE)

(73) Assignee: BASF SE, Ludwigshafen (DE)

(21) Appl. No.: 15/113,589

(22) PCT Filed: Jan. 16, 2015
(86) PCT No.: PCT/EP2015/050731

§ 371 Date: Jul. 22, 2016

(30) Foreign Application Priority Data
Jan. 22, 2014 (EP) 14152184.9

(51) Int. Cl. C04B 22/14; C04B 28/16; C04B 24/26; C01F 11/46

(52) U.S. Cl. CPC C04B 22/143; C01F 11/46; C04B 28/165; C04B 24/2694; C04B 2103/14

(57) ABSTRACT

The invention concerns a method for producing pulverulent hardening accelerators by reactive spray drying, where an aqueous phase I comprising calcium ions, and an aqueous phase II comprising sulphate ions, the molar ratio of the calcium ions to the sulphate ions being from 1/5 to 5/1, are contacted at a spray nozzle, and the phases I and II contacted with one another at the spray nozzle are sprayed in a streaming environment of drying gas. Likewise concerned are the pulverulent hardening accelerators producible by the method of the invention, and their use for accelerating the hardening of bassanite and/or anhydrite with formation of gypsum.

The present invention concerns a method for producing pulverulent, CaSO₄-based hardening accelerators by reactive spray drying, where a) an aqueous phase I, comprising liquid calcium ions, and an aqueous phase II, comprising liquid sulphate ions, the molar ratio of the calcium ions in phase I to the sulphate ions in phase II being from 1/5 to 5/1, are contacted at a spray nozzle, b) the phases I and II contacted with one another at the spray nozzle are sprayed in a streaming environment of drying gas having an entry temperature in the range from 120 to 300° C. and an exit temperature in the range from 60 to 120° C., where the calcium ions react with the sulphate ions and, with removal of water by the drying gas, the pulverulent hardening accelerator is obtained. Likewise concerned are pulverulent hardening accelerators producible by the method of the invention, and the use of the pulverulent hardening accelerators for accelerating the hardening of bassanite and/or anhydrite with formation of gypsum.

The term “gypsum” is used colloquially both for the compound calcium sulphate dihydrate (CaSO₄.2H₂O) and for the rock consisting of this compound, and the corresponding building material, calcium sulphate hemihydrate (CaSO₄.0.5H₂O or bassanite) or anhydrite (CaSO₄). Gypsum (CaSO₄.2H₂O) occurs naturally in large deposits, which formed when oceans dried out in the Earth's history. In addition, gypsum (CaSO₄.2H₂O) is obtained as a product or by-product of various processes in industry, an example being flue gas desulphurization, where sulphur dioxide is depleted from the combustion off-gases of coal-fired power plants by means of a calcium carbonate or calcium hydroxide slurry.

When heated to temperatures of 120-130° C., the calcium sulphate dihydrate releases part of its water of crystallization, and converts into bassanite. If bassanite is mixed with water, the dihydrate is reformed within a short time.

Bassanite (calcium sulphate hemihydrate) is an important building material for the production of mortars, screeds, casting moulds and, in particular, gypsum plasterboard. Owing to technical requirements, qualities which vary considerably are required of calcium sulphate binders. Particularly with regard to processing life and the time at which stiffening occurs, the binders must be variably adjustable over a period from a few minutes to several hours. In order to satisfy these requirements, the use of admixtures that regulate hardening is a necessity.

The acceleration of hardening is of crucial significance in the production of gypsum construction panels, more particularly gypsum plasterboard. At present, more than 8000 million m² of gypsum plasterboard per year are produced globally. The production of gypsum plasterboard is long-established. It is described, for example, in U.S. Pat. No. 4,009,062. The hardenable gypsum slurry used, composed of bassanite and water, is typically produced in a through-flow mixer at high rotary speed, applied continuously to a cardboard sheet, and covered with a second cardboard ply. The two cardboard sheets are referred to as the front and back boards. The line of boards then moves along what is called a setting belt, and at the end of the setting belt it is necessary for almost complete conversion of the hardenable calcium sulphate phases into calcium sulphate dihydrate to have taken place. After this hardening, the sheet is singularized into panels, and the water still present in the panels is removed in heated multi-stage driers. Gypsum plasterboard panels of this kind are used extensively in interior fitment for ceilings and walls.

In order to meet the rising demand, and also to minimize production costs, efforts are constantly being made to improve the production process. Modern plants for the fabrication of gypsum construction panels may reach manufacturing rates of up to 180 metres per minute. Maximum utilization of plant capacity is possible only through the use of high-efficiency accelerators. It is the hardening time of the bassanite here that determines the time until the gypsum plasterboard can be cut, and hence the length and speed of the conveyor belt, and therefore the production rate. In addition, hydration must be at an end before the panels are exposed to high temperatures in the drier. Otherwise, the strength potential of the binder is inadequately utilized, and the risk of volume expansion comes about as a result of post-hydration on ingress of moisture.

There is therefore a considerable economic interest in accelerating the hardening process.

Currently employed as hardening accelerator in the industrial production of gypsum plasterboard is ground gypsum (calcium sulphate dihydrate), a large portion of the particles used being in the region of 1 μm. For the continuous operation of gypsum plasterboard production, a pronounced stability of the accelerating action of the ground calcium sulphate dihydrate is of decisive significance. Production of a hardening accelerator which is consistently effective over a prolonged time period, however, continues to cause great technical problems. The effectiveness of ground calcium sulphate dihydrate, particularly in the presence of atmospheric moisture, decreases within a short time. Moreover, the ground calcium sulphate dihydrate can be used only in powder form, since introduction into water leads immediately to the dissolution of the ultra-fine particles which are crucial for the acceleration of hardening. The thesis by Müller (“Die Abbinde-beschleunigung von Stuckgips durch Calciumsulfatdihydrat” [The Acceleration of the setting of plaster of Paris by calcium sulphate dihydrate”, ISBN 978-3-899-58-328-1) discloses the unsuitability of precipitated calcium sulphate dihydrate as a hardening accelerator, and the possibility of achieving effective acceleration of hardening only by grinding of calcium sulphate dihydrate, where both the amount of ultra-fine particles in the nanometre range and the crystal lattice disruption caused during grinding are important for the efficacy.

A further accelerator also used, in addition to ground calcium sulphate dihydrate, is potassium sulphate. It has the disadvantage, however, of leading to a distinct decrease in the final compressive strength of the products produced. Using potassium sulphate also has the disadvantage that, as a result of the increase in ionic strength through the soluble sulphate introduced, the activity of other additives such as plasticizers (for example polycarboxylate ethers) or rheological additives (for example high molecular mass stabilizers based on sulphonic acid) may be adversely affected.

In order to improve the accelerating effect of ground calcium sulphate dihydrate, Portland cement or Ca(OH)₂ is also added for the purpose of activation. This, however, has the disadvantage that these additions tend towards carbonation over time, during storage, and hence are no longer so effective. The poor storage stability and hardening accelerator efficacy is, in turn, an uncertainty factor in the production of, for example, gypsum plasterboard.

Similar problems with regard to hardening accelerator activity to those experienced during gypsum plasterboard production are observed for the use of bassanite as a binder in self-levelling underlayments (SLU), anhydrite-based self-levelling screeds, plaster renders and alpha bassanite filling compounds.

WO 2005/021632 discloses a method for producing finely divided inorganic solids by precipitation of the finely divided inorganic solids from solutions. In this process, the surface of the finely divided inorganic solids is coated with at least one dispersant. Among many other compounds, precipitated calcium sulphate is disclosed as an inorganic solid, while dispersants used include, for example, acrylate or methacrylate copolymers and also their salts, polyphosphates, and modified fatty acid derivatives.

In WO 2014/012720 A1 gypsum (CaSO₄.2H₂O)-based hardening accelerators are described which are produced by wet precipitation in the presence of polymers containing acid groups. The polymers containing acid groups further comprise polyether side chains, and are known generally under the heading of polycarboxylate ethers (PCEs). The hardening accelerators produced in this way are particularly suitable for the industrial production of gypsum plasterboard.

In WO2014/122077 A1 inorganic-organic composite materials are produced by reactive spray drying of low-solubility inorganic salts. The organic component here constitutes at least one hydrophilic, usually low-solubility active ingredient, which for example may be an active pharmaceutical or cosmetic ingredient, a nutritional supplement, a crop protectant or a pigment.

The aim is to incorporate the active ingredients in finely divided form into an amorphous matrix. The low-solubility inorganic salts are formed from readily water-soluble salts of suitable cations (e.g. carbonates, hydrogencarbonates, sulphates, phosphates, hydrogenphosphates) and readily-soluble solutions of suitable anions (e.g. various calcium salts, magnesium salts and zinc salts). There is no mention as low-solubility salt of calcium sulphate, nor of any quantitative ratios of calcium ions and sulphate ions.

It was an object of the present invention, therefore, to provide a hardening accelerator for bassanite and also anhydrite that exhibits very effective acceleration of hardening. In particular, stable processing is to be made possible, not least in the production of gypsum plasterboard. The method for producing the hardening-accelerating products ought to be extremely simple and inexpensive and ought as far as possible in one step to lead to the pulverulent products.

This object has been achieved by means of a method for producing pulverulent, CaSo₄-based hardening accelerators by reactive spray drying, where a) an aqueous phase I, comprising liquid calcium ions, and an aqueous phase II, comprising liquid sulphate ions, the molar ratio of the calcium ions in phase I to the sulphate ions in phase II being from 1/5 to 5/1, are contacted at a spray nozzle, preferably a multi-channel spray nozzle, b) the phases I and II contacted with one another at the spray nozzle, preferably multi-channel spray nozzle, are sprayed in a streaming environment of drying gas having an entry temperature in the range from 120 to 300° C. and an exit temperature in the range from 60 to 120° C., where the calcium ions react with the sulphate ions and, with removal of water by the drying gas, the pulverulent hardening accelerator is obtained. The object is also achieved by means of the pulverulent hardening accelerators producible by the method of the invention, and by the use of the pulverulent hardening accelerators for accelerating the hardening of bassanite and/or anhydrite with formation of gypsum.

The pulverulent hardening accelerator produced by the method of the invention possesses outstanding activity as a hardening accelerator for bassanite and anhydrite. The single-stage production method, which leads directly to the powder product, is simple and also very economical, especially since it yields hardening accelerators, with surprisingly high efficiency, even without relatively expensive stabilizing polymer additives.

The pulverulent CaSO₄-based hardening accelerator preferably comprises bassanite (CaSO₄.0.5 H₂O) and is preferably a hardening accelerator for the binder bassanite (in both the α-form and the β-form) and also anhydrite (CaSO₄). Preferred anhydrite as binder is thermal anhydrite, which comes from flue gas desulphurization, and synthetic anhydrite, which comes from the production of hydrofluoric acid by reaction of calcium fluoride with sulphuric acid. A preferred binder is bassanite, and with particular preference the bassanite binder used is more than 95% crystalline. Reactive spray drying denotes, preferably, a process in which a chemical reaction, namely the reaction of calcium ions and sulphate ions, and a spray drying operation are combined. The contacting of the phases I and II with one another, which equates to a mixing of the two phases, initiates the chemical reaction to form CaSO₄-based products.

The hardening accelerator obtained in the method of the invention comprises preferably 25 to 60 wt % of bassanite, more preferably 30 to 55 wt % of bassanite, preferably less than 5 wt % of anhydrite, more preferably 1 to 2 wt % of anhydrite, and preferably less than 5 wt % of gypsum, more preferably 1 to 2 wt % of gypsum. The weight figures quoted above relate only to crystalline phases, and come from XRD experiments. Amorphous constituents are therefore not detected. In addition, of course, as a result of the choice of the starting materials, salts of the starting materials are also present, examples being MgCl₂.6 H₂O and CaMgCl₄.12 H₂O in the case of magnesium sulphate and calcium chloride.

Water-soluble calcium compounds and water-soluble sulphate compounds contemplated in phases I and II include in each case in principle also those compounds of only relatively poor solubility in water, although preference is given in each case to readily water-soluble compounds, which dissolve completely or almost completely in water. It is nevertheless necessary to ensure that in an aqueous environment with the corresponding reaction partner, i.e. the water-soluble calcium compound and the water-soluble sulphate compound, the reactivity present is sufficient for the reaction.

Besides water and the respective ions, there may also be one or more further solvents present in the aqueous, liquid phase I or II. For example, ethanol or isopropanol is preferred.

The concentration of the calcium ions in the method, in the liquid phase I, is preferably in the range from 0.1 to 3 mol/l, more preferably from 0.3 to 2.5 mol/l, especially preferably from 0.5 to 2.1 mol/1 and more particularly preferably from 0.5 to 2.0 mol/l, most preferably from 0.5 to 1.5 mol/l. The concentration of the sulphate ions in the liquid phase II is preferably in the range from 0.1 to 3 mol/l, more preferably from 0.3 to 2.5 mol/l, especially preferably from 0.5 to 2.1 mol/1 and more particularly preferably from 0.5 to 2.0 mol/l, most preferably from 0.5 to 1.5 mol/l. With particular preference, the respective concentration of the calcium ions in the liquid phase I and of the sulphate ions in the liquid phase II is within the preferred ranges specified above. All figures given above for the concentration of the calcium ions and of the sulphate ions are based on water as the solvent and on a temperature of 20° C. and on atmospheric pressure. It is also possible to vary the rates of supply and also the concentration of the calcium ions in the liquid phase I and of the sulphate ions in the liquid phase II during the method, and consequently, at any given point in time during the method, the amounts of calcium ions and sulphate ions contacted with one another may be different. Preference is given to a method wherein the molar ratio of calcium ions in the liquid phase I to sulphate ions from the liquid phase II is constant.

The molar ratio of the calcium ions to the sulphate ions is from 1/5 to 5/1, preferably from 1/3 to 3/1, especially preferably from 1/2 to 2/1, more preferably from 1/1.5 to 1.5/1, and most preferably from 1/1.2 to 1.2/1. The molar ratio of the calcium ions to the sulphate ions is preferably defined as the molar ratio of the total amount of calcium ions and sulphate ions used in the method. An excess of calcium to sulphate or vice versa, in other words a deviation from the stoichiometric molar ratio of 1/1, is possible. It is advantageous, however, to select the ratio of calcium to sulphate close to the region of 1/1.

The calcium ion-containing phase I is contacted with the sulphate ion-containing phase II preferably at the spray nozzle, and sprayed, to form reaction products based on calcium sulphate.

This is followed in step b) by drying through the spray-drying process. Steps a) and b) are preferably implemented continuously, thus requiring no extra labour effort in the sense of a sequence that must be undertaken of process measures in the experimental or production environment. Supplied with preference, more particularly continuously, are the liquid phases I and II, likewise the atomizer gas and the hot drying gas required for drying. The end product is taken off continuously, preferably by means of a suitable separating apparatus for pulverulent products. From the sector of spray drying technology, the appropriate measures for optimizing the parameters of feed rate of phases I and II, feed rate of the atomizer gas and of the drying gas, together with the necessary take-off rate of the end product, are sufficiently known to the skilled person, and can be optimized. The required residence time is optimized in order to maximize product throughput in connection with consistently good product quality (efficiency as hardening accelerator, and degree of drying). The method is preferably characterized in that the average residence time in the spray drying reactor is from 0.5 to 120 seconds.

The method of the invention is preferably a continuously operated process. The method is preferably operated without removal of any by-products.

The solids content of the pulverulent, CaSO₄-based hardening accelerator is preferably more than 70 wt %, more preferably more than 75 wt % and especially preferably from 75 to 85 wt %. The solids content has been determined using an HR73 halogen moisture analyser from Mettler Toledo. Approximately 1 g of sample was weighed out onto aluminium weighing pans, 100 mm in diameter×7 mm in height (=weight (t=0)) and placed in the instrument. The sample was dried to constant weight (5 s) at 130° C. Solids content (wt %)=final weight (t=end)/weight (t=0) 100%.

The pulverulent CaSO₄-based hardening accelerator contains preferably less than 30 wt % of water, more preferably less than 25 wt % of water, especially preferably from 25 to 15 wt % of water, the water content of the hardening accelerator samples being calculated according to the method stated above for determining the solids content, by the following formula:

Water content (wt %)=100 wt %−solids content (wt %).

Salt compounds are known also to have what is called water of crystallization. The water content as determined by the method stated above, therefore, is not necessarily the absolute water content (free water plus water of crystallization), since it is known to be usually very difficult to remove completely the water of crystallization as well from salts by means of corresponding thermal treatment, and while avoiding decomposition reactions. The water content quoted is instead that determined by the method indicated.

Surprisingly it has been found that particularly effective hardening accelerators are obtained from the method of the invention and can be obtained even without addition of stabilizing additives such as polymers. It is thought that as a result of the rapid drying of the mixed liquid phases I and II, hardening accelerators can be obtained with particularly low crystallite sizes. These are particularly efficient as hardening accelerators.

All conventional spraying devices are suitable for implementing the method of the invention.

Suitable spraying nozzles are multi-channel nozzles such as two-fluid nozzles, three-channel nozzles or four-channel nozzles. Such nozzles may also take the form of what are called “ultrasound nozzles”. Nozzles of this kind are available commercially per se.

Furthermore, according to nozzle type, an atomizing gas may also be supplied. Air or an inert gas such as nitrogen or argon may be used as the atomizing gas. The gas pressure of the atomizing gas may be up to 1 MPa absolute, preferably 0.12 to 0.5 MPa absolute.

Also suitable according to one embodiment are speciality nozzles in which the various liquid phases are mixed within the nozzle body and then atomized.

One embodiment of the invention concerns ultrasound nozzles. Ultrasound nozzles may be operated with or without atomizing gas. In the case of ultrasound nozzles, atomizing comes about by the phase to be atomized being set in vibration. Depending on nozzle size and design, the ultrasound nozzles may be operated with a frequency of 16 to 120 kHz.

The throughput of liquid phase for spraying, per nozzle, is dependent on the nozzle size. The throughput may be 500 g/h to 1000 kg/h. For the production of commercial quantities, the throughput is preferably in the range from 10 to 1000 kg/h.

If no atomizing gas is used, the liquid pressure may be 0.2 to 20 MPa absolute. If an atomizing gas is used, the liquid may be supplied unpressurized.

Furthermore, the spray drying apparatus is supplied with a drying gas such as air or one of the inert gases mentioned. The drying gas may be supplied cocurrently with or countercurrently to the sprayed liquid, preferably cocurrently. The entry temperature of the drying gas can be 120 to 300° C., preferably 150 to 200° C., the exit temperature 60 to 120° C.

As already mentioned, the magnitudes of the spray parameters to be used, such as throughput, gas pressure or nozzle diameter, are crucially dependent on the size of the apparatus. The apparatus are available commercially, and the manufacturer typically recommends corresponding magnitudes.

In accordance with the invention, the spraying process is preferably operated in such a way that the average drop size of the sprayed phases is 5 to 2000 μm, preferably 5 to 500 μm, more preferably 5 to 200 μm. The average drop size may be determined by means of laser diffraction or high-speed cameras coupled with an image analysis system.

The observations above concerning the spraying process may be applied to all preferred and more preferred embodiments that are outlined below. Preferred spraying parameters are also preferred in connection with the embodiments below.

Preference is given to a method characterized in that the spray nozzle is a multi-channel nozzle.

The spraying of the phases I and II contacted with one another at the spray nozzle takes place preferably through a multi-channel nozzle.

The multi-channel nozzle may preferably be a three-channel nozzle or else a two-channel nozzle. In the case of the three-channel nozzle, preferably an atomizer gas, more preferably air or nitrogen, is used for one of the three channels; the other two channels are for phases I and II. In the case of a two-channel nozzle, the necessary atomization of the phases I and II is achieved either through the use of ultrasound or through the use of a centrifugal-force nozzle.

Preference is given to using a three-channel nozzle with one channel for the atomizer gas and two channels for the phases I and II. In the case both of a two-channel nozzle and of a three-channel nozzle, the channels of the phases I and II are separate, in order to prevent premature mixing of the phases. Phases I and II are contacted with one another only at the outlet of the two channels for the phases I and II in the spray nozzle. The atomizer gas brings about the formation of fine droplets (a kind of mist) from the phases I and II contacted with one another.

Preference is given to a method characterized in that the multi-channel nozzle possesses at least two channels, in which the aqueous phase I comprising liquid calcium ions and the aqueous phase II comprising liquid sulphate ions are supplied separately to the two channels, and the phases I and II are contacted with one another at the outlet of the channels of the nozzle.

Preference is given to a method where an aqueous solution of a calcium salt is used as phase I and an aqueous solution of a sulphate salt or of a sulphate ion-forming acid is used as phase II, characterized in that the solubility of the calcium salt in the aqueous phase I is greater than 0.1 mol/1 and the solubility of the sulphate salt or of the sulphate ion-forming acid in the aqueous phase II is greater than 0.1 mol/l, all solubilities being based on the temperature of 20° C. and atmospheric pressure. The formation of calcium sulphate from readily soluble calcium salts and readily soluble sulphate salts is particularly preferred both kinetically and thermodynamically, and in practice can also be accomplished with particular ease with high conversion rates.

A preferred method is characterized in that the concentration of the calcium ions in phase I is from 0.1 mol/1 to 3.5 mol/1 and the concentration of the sulphate ions in phase II is from 0.1 mol/1 to 3.5 mol/l.

A preferred method is characterized in that the calcium salt used is a salt from the series calcium acetate, calcium formate, calcium chloride, calcium bromide, calcium iodide, calcium hydroxide, calcium sulphamidate, calcium lactate, calcium methanesulphonate, calcium propionate, calcium nitrate and/or calcium carbonate.

Calcium carbonate is less suitable on account of its low solubility in water, though, particularly at low pH levels, it is a possible option, or else when sulphuric acid is used as a source of sulphate ions.

A preferred method is characterized in that the sulphate salt used comprises alkali metal sulphates, ammonium sulphate, aluminium sulphate and/or magnesium sulphate, or the sulphate ion-forming acid used comprises sulphuric acid. The stated sulphates are suitable in particular on account of their ready solubility in water. Preferred alkali metal sulphates are sodium sulphate and potassium sulphate.

A preferred method is characterized in that the spraying of the phases I and II produces droplets having an average drop size of 5 to 2000 μm. The average drop size may be determined by laser diffraction during the reactive spray drying process, or by high-speed cameras coupled with an image analysis system.

A preferred method is characterized in that one of the phases, I or II, or both phases, I and II, comprises or comprise a polymer containing acid groups, or a salt of said polymer, with an average molecular weight M_{w} of 5000 g/mol to 100 000 g/mol.

For example, the polymer containing acid groups may be selected from the series polyacrylic acid, polymethacrylic acid, polyvinylphosphonic acid, and copolymers comprising acrylic acid, methacrylic acid, vinylsulphonic acid, 2-acrylamido-2-methylpropanesulphonic acid and vinylphosphonic acid. Especially preferred are polyacrylic acid, polymethacrylic acid and polyvinylphosphonic acid.

The salts of the polymers containing acid groups may be present preferably in the form of the ammonium salt, alkali metal salt and/or alkaline earth metal salt. Ammonium salts and/or alkali metal salts are particularly preferred. Alkaline earth metal salts have a tendency with polyelectrolytes to enter into unwanted gelling, thereby restricting their usefulness. If a calcium salt is employed, it would be necessary to take account of the corresponding amount of calcium ions when calculating the amount of calcium ions used in the method. In this case, the calcium salt of the polymer containing acid groups ought to be used preferably in the liquid phase I and not in the sulphate-containing liquid phase II, owing to unwanted premature formation of CaSO₄ salts in the channel. All alkaline earth metal salts, with the exception of magnesium, and more particularly calcium salts, of the polymers containing acid groups are less preferred.

A preferred method is characterized in that based on the mass of the CaSO₄, between 0.005 and 100 wt %, preferably 0.1 and 50 wt %, more preferably 0.3 and 10 wt %, especially preferably between 0.5 and 5 wt % of the polymer containing acid groups, or salt of said polymer, is used.

In addition to the rapid drying of the freshly formed CaSO₄ particles in the spray-drying operation, these polymers containing acid groups help to stabilize fine particles of CaSO₄.0.5 H₂O and to prevent conglomeration. As a result, the activity of the hardening accelerators is positively influenced.

A preferred method is characterized in that the acid group of the polymer is at least one from the series carboxyl, phosphono, sulphino, sulpho, sulphamido, sulphoxy, sulphoalkyloxy, sulphinoalkyloxy and phosphonooxy group. Particularly preferred are carboxyl and phosphonooxy groups.

A preferred method is characterized in that the polymer containing acid groups comprises polyether groups. The polyether groups improve the solubility and efficiency of the polymers as stabilizers.

A preferred method is characterized in that the polymer containing acid groups, preferably copolymer containing acid groups, comprises polyether groups of the structural unit (I),

*—U—(C(O))ₖ—X-(AlkO)ₙ—W (I)
where
* indicates the location of bonding to the polymer containing acid groups,
U is a chemical bond or an alkylene group having 1 to 8 C atoms,
X is oxygen or a group NR,
k is 0 or 1,
n is an integer whose average value, based on the polymer containing acid groups, is in the range from 3 to 300,
Alk is alkylene, preferably C₂-C₄ alkylene, it being possible for Alk to be identical or different within the group (Alk-O)ₙ,
W is a hydrogen, an alkyl radical, preferably a C₁-C₆ alkyl radical, or an aryl radical, or W denotes the group Y—F, where
Y is a linear or branched alkylene group having 2 to 8 C atoms and may carry a phenyl ring,
F is a 5- to 10-membered nitrogen heterocycle which is bonded via nitrogen and which as ring members, besides the nitrogen atom and besides carbon atoms, may have 1, 2 or 3 additional heteroatoms, selected from oxygen, nitrogen and sulphur, it being possible for the nitrogen ring members to have a group R², and it being possible for 1 or 2 carbon ring members to be present in the form of carbonyl group,
R¹ is hydrogen, C₁-C₄ alkyl or benzyl, and
R² is hydrogen, C₁-C₄ alkyl or benzyl.

A preferred method is characterized in that the polymer containing acid groups constitutes a polycondensation product comprising
(II) a structural unit comprising an aromatic or heteroaromatic and a polyether group of the structural unit (I) and
(III) a phosphated structural unit comprising an aromatic or heteroaromatic.

U in the structural unit (I) is preferably a chemical bond, and k is preferably 0 when the structural unit (I) is present in the structural unit (II)—a structural unit comprising an aromatic or heteroaromatic and a polyether group of the structural unit (I).

A preferred method is characterized in that the structural units (II) and (III) are obtained by copolymerization of monomers; preferably by polycondensation of monomers, which are represented by the following general formulae:

A-U—(C(O))ₖ—X-(AlkO)ₙ—W (IIa)
with
A being identical or different and also represented by a substituted or unsubstituted aromatic or heteroaromatic compound having 5 to 10 C atoms in the aromatic system, the further radicals possessing the definition stated above for structural unit (I); A is preferably a phenyl radical, U is preferably a chemical bond, k is preferably 0, X is preferably oxygen, and W is preferably an alkyl radical or hydrogen and

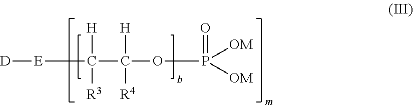

with
D being identical or different and also represented by a substituted or unsubstituted aromatic or heteroaromatic compound having 5 to 10 C atoms in the aromatic system,
with
E being identical or different and also represented by N, NH or O,
with
m=2 if E=N, and m=1 if E=NH or O,
with
R³ and R⁴ independently of one another being identical or different and also represented by a branched or unbranched C₁ to C₁₀ alkyl radical, C₅ to C₈ cycloalkyl radical, aryl radical, heteroaryl radical or H; preferably R³ or R⁴ is H, more preferably R³ and R⁴ are H;
with b
being identical or different and also represented by an integer from 0 to 300, preferably 1 to 300, more preferably 1 to 100, especially preferably 1 to 5, and
with M being H or one cation equivalent.

The phosphate esters of the general formula (III) may be present in the acid form with two H atoms (M=H). The phosphate esters may also be present in their deprotonated form, with the H atom being replaced by one cation equivalent. Partial replacement of the H atoms by one cation equivalent is likewise possible. The term “cation equivalent” denotes preferably any metal ion or an optionally substituted ammonium ion which is able to replace the proton of the acid, with the proviso that the structures (III) are electrically neutral. Consequently, in the case of an alkaline earth metal (two positive charges), for example, a factor of must be applied in order to ensure neutrality (for example M=½ alkaline earth metal); in the case of aluminium as cation equivalent, M=⅓ Al would apply. Mixed cation equivalents with, for example, two or more different cation equivalents are likewise possible. M is preferably H, NH₄, an alkali metal or ½ alkaline earth metal; more preferably M is H, an alkali metal and/or NH₄.

A preferred method is characterized in that the polycondensation product comprises a further structural unit (IV) which is represented by the following

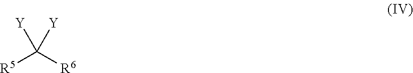

with
Y independently of one another being identical or different and represented by (II), (III) or other constituents of the polycondensation product;
   R⁵ and R⁶ are preferably identical or different and are represented by H, CH₃, COOH or a substituted or unsubstituted aromatic or heteroaromatic compound having 5 to 10 C atoms.

Further constituents of the polycondensation product may be, for example, phenol or methyl-substituted phenols (cresols). The amount thereof is preferably less than 30 mol % relative to all aromatic structural units in accordance with the structural units (II) and (III).

Here, R⁵ and R⁶ in structural unit (IV), independently of one another, are preferably represented by H, COOH and/or methyl.

In one particularly preferred embodiment, R⁵ and R⁶ are represented by H.

The molar ratio of the structural units (II), (III) and (IV) in the phosphated polycondensation product of the invention may be varied within wide ranges.

It has proved to be judicious for the molar ratio of the structural units [(II)+(III)]: (IV) to be 1:0.8 to 3, preferably 1:0.9 to 2 and more preferably 1:0.95 to 1.2.

The molar ratio of the structural units (II): (III) is normally 1:10 to 10:1, preferably 1:7 to 5:1 and more preferably 1:5 to 3:1.

The groups A and D in structural units (II) and (III) of the polycondensation product are represented mostly by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, preferably phenyl, and A and D may be selected independently of one another and may also each consist of a mixture of the stated compounds. The groups X and E are represented, independently of one another, preferably by O.

Preferably, in structural unit (I), n is represented by an integer from 5 to 280, more particularly 10 to 160 and more preferably 12 to 120, and in structural unit (III), b is represented by an integer from 0 to 10, preferably 1 to 7 and more preferably 1 to 5. The respective radicals whose length is defined by n or b may here consist of unitary structural groups, though it may also be judicious for there to be a mixture of different structural groups. Moreover, the radicals of the structural units (II) and (III) may independently of one another each possess the same chain length, with n or b each being represented by one number. In general, however, it will be judicious for there to be in each case mixtures with different chain lengths, and so the radicals of the structural units in the polycondensation product have different numerical values for n and, independently, for b.

In one particular embodiment, moreover, the present invention provides for the product in question to be a sodium, potassium and/or ammonium salt of the phosphated polycondensation product.

The phosphated polycondensation product of the invention frequently has a weight-average molecular weight of 4000 g/mol to 150 000 g/mol, preferably 10 000 to 100 000 g/mol and more preferably 20 000 to 75 000 g/mol.

With regard to the phosphated polycondensation products for preferred use in accordance with the present invention, and their preparation, reference is made additionally to Patent Applications WO 2006/042709 and WO 2010/040612, whose content is hereby incorporated into the present application.

A preferred method is characterized in that the polymer containing acid groups constitutes at least one copolymer which is obtainable by polymerization of a mixture of monomers comprising
(V) at least one ethylenically unsaturated monomer which comprises at least one radical from the series carboxylic acid, carboxylic salt, carboxylic ester, carboxylic amide, carboxylic anhydride and carboxylic imide and
(VI) at least one ethylenically unsaturated monomer having a polyether group of the structural unit (I).

The copolymers in accordance with the present invention comprise at least two monomer units. It may, however, also be advantageous to use copolymers having three or more monomer units.

A preferred method is characterized in that the ethylenically unsaturated monomer (V) is represented by at least one of the following general formulae from the group (Va), (Vb) and (Vc):

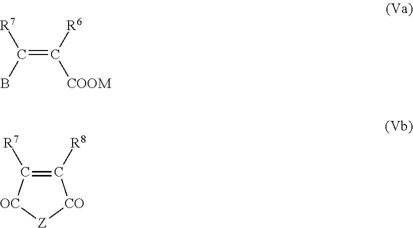

where
R⁷ and R⁸ independently of one another are hydrogen or an aliphatic hydrocarbon radical having 1 to 20 C atoms, B is H, —COOM, —CO—O(C_{q}H_{2q}O)ᵣ—R⁹ or —CO—NH—(C_{q}H_{2q}O)ᵣ—R⁹,
M is H or one cation equivalent,
R⁹ is hydrogen, an aliphatic hydrocarbon radical having 1 to 20 C atoms, a cycloaliphatic hydrocarbon radical having 5 to 8 C atoms, or an optionally substituted aryl radical having 6 to 14 C atoms,
q independently at each occurrence for each (C_{q}H_{2q}O) unit is identical or different and is 2, 3 or 4, preferably 2, and
r is 0 to 200,
Z is O or NR³;
where R³ is identical or different and is represented by a branched or unbranched C₁ to C₁₀ alkyl radical, C₅ to C₈ cycloalkyl radical, aryl radical, heteroaryl radical or H,

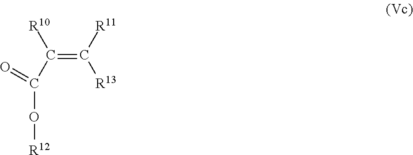

with
R¹⁰ and R¹¹ independently of one another being hydrogen or an aliphatic hydrocarbon radical having 1 to 20 C atoms, a cycloaliphatic hydrocarbon radical having 5 to 8 C atoms, or an optionally substituted aryl radical having 6 to 14 C atoms,
R¹² being identical or different and also represented by (CₙH₂ₙ)—SO₃M with n=0, 1, 2, 3 or 4, (CₙH₂ₙ)—OH with n=0, 1, 2, 3 or 4; (CₙH₂ₙ)—PO₃M₂ with n=0, 1, 2, 3 or 4, (CₙH₂ₙ)—OPO₃M₂ with n=0, 1, 2, 3 or 4, (C₆H₄)—SO₃M, (C₆H₄)—PO₃M₂, (C₆H₄)—OPO₃M₂ and (CₙH₂ₙ)—NR¹⁴_{b} with n=0, 1, 2, 3 or 4 and b=2 or 3,
R¹³ being H, —COOM, —CO—O(C_{q}H_{2q}O)ᵣ—R⁹ or —CO—NH—(C_{q}H_{2q}O)ᵣ—R⁹,
   where M, R⁹, q and r possess definitions stated above,
R¹⁴ being hydrogen, an aliphatic hydrocarbon radical having 1 to 10 C atoms, a cycloaliphatic hydrocarbon radical having 5 to 8 C atoms, or an optionally substituted aryl radical having 6 to 14 C atoms, and
Q being identical or different and also represented by NH, NR¹⁵ or O; where R¹⁵ is an aliphatic hydrocarbon radical having 1 to 10 C atoms, a cycloaliphatic hydrocarbon radical having 5 to 8 C atoms, or an optionally substituted aryl radical having 6 to 14 C atoms.

M is H or one cation equivalent, preferably H, NH₄, an alkali metal or alkaline earth metal; more preferably, M is H, an alkali metal and/or NH₄.

In the monocarboxylic or dicarboxylic acid derivative (Va) and in the monomer (Vb) present in cyclic form, where Z═O (acid anhydride) or NR⁷ (acid imide), R⁷ and R⁸ independently of one another are hydrogen or an aliphatic hydrocarbon radical having 1 to 20 C atoms, preferably a methyl group. B denotes H, —COOM, —CO—O(C_{q}H_{2q}O)ᵣ—R⁹, or —CO—NH—(C_{q}H_{2q}O)ᵣ—R⁹. M denotes preferably hydrogen or one cation equivalent, preferably one monovalent or ½ a divalent metal cation, preferably sodium, potassium, ½ calcium or ½ magnesium ion, or else ammonium or an organic amine radical. Organic amine radicals used are preferably substituted ammonium groups which derive from primary, secondary or tertiary C₁₋₂₀ alkylamines, C₁₋₂₀ alkanolamines, C₅₋₈ cycloalkylamines and C₆₋₁₄ arylamines. Examples of the amines in question are methylamine, dimethylamine, trimethylamine, ethanolamine, diethanolamine, triethanolamine, methyldiethanolamine, cyclohexylamine, dicyclohexylamine, phenylamine, diphenylamine in the protonated (ammonium) form.

R⁹ denotes hydrogen, an aliphatic hydrocarbon radical having 1 to 20 C atoms, a cycloaliphatic hydrocarbon radical having 5 to 8 C atoms, an aryl radical having 6 to 14 C atoms, which may optionally be further substituted, q=2, 3 or 4 and r=0 to 200, preferably 1 to 150. The aliphatic hydrocarbons here may be linear or branched and also saturated or unsaturated. Considered preferred cycloalkyl radicals are cyclopentyl or cyclohexyl radicals, and considered preferred aryl radicals are phenyl or naphthyl radicals, which in particular may also be substituted by hydroxyl, carboxyl or sulphonic acid groups.

In one particularly preferred embodiment, the ethylenically unsaturated monomer (VI) is represented by the following general formula:

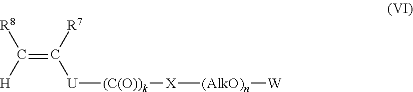

in which all radicals have the definitions stated above.

With regard to the method of the invention, based on the sum of the masses of calcium and sulphate employed, preferably between 0.005 and 100 wt %, more particularly between 0.01 and 50 wt %, especially preferably between 0.02 and 30 wt %, more preferably between 0.03 and 15 wt % and most preferably between 0.05 and 10 wt % of the polymer containing acid groups is used.

The invention also relates to pulverulent hardening accelerators producible by the method of the invention.

The crystallite size of the bassanite present in the hardening accelerators producible by the method of the invention is from 1 to 45 nm, preferably from 1 to 40 nm, more preferably from 1 to 30 nm and most preferably from 5 to 30 nm.

The crystallite size of the pulverulent hardening accelerators, particularly of the bassanite present therein, was determined by means of x-ray diffraction (XRD, Bruker D8 Discover) with subsequent Rietveld analysis (The Rietveld Method, edited by R. A. Young, 2002, International Union of Crystallography monographs on crystallography: 5, ISBN 0-19-855912-7). The measurement was carried out using CuKα radiation in a 5-60° 2θ measurement range with a step width of 0.02° and a count time per step of 0.4 second. For the Rietveld evaluation, the Topas 4.2 software with fundamental parameter approach, from Bruker, was used. This determination of the crystallite size in the bassanite phase is based on the refining and adaptation of the diffraction pattern of the structure for bassanite (ICSD Database #79529). The parameter evaluated was the Lorentz crystallite size (Topas Parameter “Cry Size L” in nm), which results from the refining on the basis of adapted peak widths. It should be borne in mind here that the crystallite sizes cannot automatically be equated with the particle sizes.

The invention also relates to a pulverulent hardening accelerator producible by a method according to this invention, wherein the crystallite size of the bassanite present in the hardening accelerators producible by the method of the invention is from 1 to 45 nm, wherein the crystallite size of the bassanite was determined by means of x-ray diffraction with subsequent Rietveld analysis and details of the method employed are given on page 28, lines 1 to 21 of the description.

The invention also relates to the use of the pulverulent hardening accelerator producible by the method of the invention for accelerating the hardening of bassanite and/or anhydrite with formation of gypsum.

The bassanite (binder) whose hardening is accelerated is preferably characterized in that the crystallite size is greater than 50 nm, more preferably greater than 60 nm and especially preferably greater than 70 nm, the crystallite size being determined in accordance with the method specified above, by x-ray diffraction with subsequent Rietveld analysis.

The metering of the hardening accelerator producible by the method of the invention is preferably from 0.01 to 1 wt %, more preferably from 0.02 to 0.5 wt %, especially preferably from 0.025 to 0.1 wt %, based on the mass of CaSO₄ in the respective binder (bassanite or anhydrite).

A preferred use of the pulverulent hardening accelerator producible by the method of the invention is for accelerating the hardening of the bassanite and/or anhydrite with formation of gypsum, for the production of gypsum plasterboard.

If the hardening accelerators of the invention are used for the accelerated hardening of self-levelling anhydrite screeds, it has proved to be particularly advantageous that the phenomenon known as bleeding (incidence of free water on the surface of the screed) can be largely avoided, or prevented.

A preferred use of the pulverulent hardening accelerator producible by the method of the invention is for accelerating the hardening of a bassanite and/or anhydrite with formation of gypsum, in a bassanite filling compounds and anhydrite-based self-levelling screeds.

The examples which follow illustrate the advantages of the present invention.

### EXAMPLES

### Production of the Inorganic Hardening Accelerators Via a Reactive Spraying Process

General Procedure 1 (without Addition of Polymer):

Prepared were an aqueous solution of CaCl₂ and an aqueous solution of MgSO₄ with defined concentration as described in Table 1a or 1b. These solutions are filtered through a 1 μm Acrodisc glass fibre filter. Subsequently these solutions were introduced into a pressurizable glass bottle (from Schott), and a pressure of 1.5 bar was applied. The solutions were introduced with exact stoichiometry or at different flow rates as described in Table 1, via Bronkhorst mini Cori-Flow™ flow regulators with pre-positioned 30 μm steel filter, into a B-290 spraying tower from Büchi. The flow regulators were connected by a Master-Slave circuit and are driven digitally by a computer. The spraying tower was equipped with a 0465555 three-fluid nozzle, a 004189 cylcone separator and a 044673 glass tower from Büchi. The inner channel was fed with the MgSO₄ solution, and the outer channel with the CaCl₂ solution. The drying gas used was nitrogen, with a flow rate of 65 m³/h. The entry temperature of the drying gas was varied as described in Table 1; the corresponding exit temperature of the drying gas was likewise measured and is listed in Table 1. The spray nozzle was cooled with process water. The flow rate of the atomizing gas (N₂) was 819 Nl/h (STP).

General Procedure 2 (with Addition of Polymer):

Prepared were an aqueous solution of CaCl₂ and an aqueous solution of MgSO₄ additionally containing an amount as specified in Table 1a or 1b of the polymer Melflux® 2650 L (BASF Construction Solutions GmbH) in phase II (MgSO₄ solution).

The comb polymer Melflux® 2650 L is a commercially available polycarboxylate ether from BASF Construction Solutions GmbH. The polymer is based on the monomers maleic acid, acrylic acid and vinyloxybutyl-polyethylene glycol 5800; M_{w}=36 000 g/mol, determined by GPC; the solids content is 33%.

These solutions are filtered through a 1 μm Acrodisc glass fibre filter. Subsequently these solutions were introduced into a pressurizable glass bottle (from Schott), and a pressure of 1.5 bar was applied. The solutions were introduced with exact stoichiometry or at different flow rates as described in Table 1a and Table 1b, via Bronkhorst mini flow regulators with pre-positioned 30 μm steel filter, into a B-290 spraying tower from Büchi. The flow regulators were connected by a Master-Slave circuit and are driven digitally by a computer. The spraying tower was equipped with a 0465555 three-fluid nozzle, a 004189 cylcone separator and a 044673 glass tower from Büchi. The inner channel was fed with the MgSO₄ solution, and the outer channel with the CaCl₂ solution. The drying gas used was nitrogen, with a flow rate of 65 m³/h. The entry temperature of the drying gas was varied as described in Tables 1a and 1b; the corresponding exit temperature of the drying gas was likewise measured and is listed in Table 1. The spray nozzle was cooled with process water. The flow rate of the atomizing gas was 819 Nl/h (STP).

Measurement of the Solids Content:

The solids content (SC) has been determined using an HR73 halogen moisture analyser from Mettler Toledo. Approximately 1 g of sample was weighed out onto aluminium weighing pans, 100 mm in diameter×7 mm in height and placed in the instrument.

The sample was dried to constant weight (5 s) at 130° C.

Solids content(wt %)=final weight(t=measurement end point)/weight(t=0)·100%.

TABLE 1a
Production of the hardening accelerators (equimolar)

| | | | | | Pumping | | | |
|---|---|---|---|---|---|---|---|---|
| | | | Melflux ® | | rate of | | | |
| | | | 2650 (wt % | | phase I | | | Solids |
| Ex. | | | based on | Drying | and phase | Inlet | Outlet | content |
| No.: | Phase I | Phase II | CaSO₄) | gas | II | temperature | temperature | wt % |
| 1 | 0.4M CaCl₂ | 0.4M MgSO₄ + | 3.8% | nitrogen | 5 ml/min | 210° C. | 99-102° C. | 84 |
| | | Melflux ® 2650 L | | | | | | |
| 2 | 2M CaCl₂ | 2M | — | nitrogen | 6 ml/min | 220° C. | 90-93° C. | 82 |
| | | MgSO₄ | | | | | | |
| 3 | 2M CaCl₂ | 2M MgSO₄ | 1.9% | nitrogen | 6 ml/min | 220° C. | 95-98° C. | 82 |
| | | Melflux ® 2650 L | | | | | | |

TABLE 1b
Production of the hardening accelerators with different molar ratios

| | | | | Melflux ® | | | | |
|---|---|---|---|---|---|---|---|---|
| | | Phase I | | 2650 (wt % | Phase II | | | |
| Ex. | | metering | | based on | metering | | Inlet | Outlet |
| No.: | Phase I | rate | Phase II | CaSO₄) | rate | Drying gas | temperature | temperature |
| 4 | 0.4M CaCl₂ | 5 ml/min | 0.4M MgSO₄ | 3.9% | 2.5 ml/min | nitrogen | 205° C. | 89-92° C. |
| 5 | 0.4M CaCl₂ | 2.5 ml/min | 0.4M MgSO₄ | 3.9% | 5 ml/min | nitrogen | 195° C. | 85-88° C. |
| 6 | 0.4M CaCl₂ | 5 ml/min | 0.4M MgSO₄ | — | 5 ml/min | nitrogen | 205° C. | 86-89° C. |
| 7 | 0.4M CaCl₂ | 5 ml/min | 0.4M MgSO₄ | — | 2.5 ml/min | nitrogen | 195° C. | 82-86° C. |
| 8 | 0.4M CaCl₂ | 2.5 ml/min | 0.4M MgSO₄ | — | 5 ml/min | nitrogen | 195° C. | 81-85° C. |

The physical properties of the hardening accelerator samples used are summarized in Table 2.

For the determination of the amount of bassanite and also of the crystallite size of bassanite, the pulverulent hardening accelerator, more particularly the bassanite present therein, was analysed by means of x-ray diffraction (XRD, Bruker D8 Discover) with subsequent Rietveld analysis (The Rietveld Method, edited by R. A. Young, 2002, International Union of Crystallography monographs on crystallography: 5, ISBN 0-19-855912-7). The measurement was carried out using CuKα radiation in a 5-60° 2θ measurement range with a step width of 0.02° and a count time per step of 0.4 second. For the Rietveld evaluation, the Topas 4.2 software with fundamental parameter approach, from Bruker, was used. This determination of the crystallite size in the bassanite phase is based on the refining and adaptation of the diffraction pattern of the structure for bassanite (ICSD Database #79529). The parameter evaluated was the Lorentz crystallite size (Topas Parameter “Cry Size L” in nm), which results from the refining on the basis of adapted peak widths. It should be borne in mind here that the crystallite sizes cannot automatically be equated with the particle sizes.

TABLE 2
Crystallite size (from XRD measurements) and
bassanite content

| Hardening | | Bassanite content |
|---|---|---|
| accelerator Ex. | Crystallite size | of hardening |
| No.: | (nm) | accelerator (wt %) |
| 1 | 18.8 | 39.8 |
| 2 | 17.9 | 40.4 |
| 3 | 20.1 | 37.9 |
| 4 | 37.6 | 50.5 |
| 5 | 20.0 | 49.3 |
| 6 | 20.5 | 36.4 |
| 7 | 19.1 | 44.0 |
| 8 | 12.3 | 53.1 |

For comparison, for example, the crystallite size of a representative, bassanite-based binder (Schwarze Pumpe from Knauf), at 72.8 nm, is substantially larger than the hardening accelerators of the invention.

The crystallite size of bassanite-based binders ranges typically from 50 nm to about 200 nm, and is therefore substantially larger.

Calorimetric Determination of the Hardening Accelerator Performance

Since the bassanite binder has too high a reactivity to be analysed by heat flow calorimetry, the reaction is first of all retarded. For the measurement, 40 g of bassanite binder (Sigma-Aldrich>97%) are admixed with a mixture of 15 g of water and 25 g of a 0.056% strength solution of a calcium salt of an N-polyoxymethylene-amino acid (Retardan P retarder from Sika AG). The resulting composition is stirred for 60 seconds with an axial stirrer at 750 revolutions per minute. During a subsequent pause of 30 seconds, the respective accelerator is added, at a rate of 0.067 wt % of bassanite present in the accelerator (bassanite contents are disclosed in Table 2), based on the bassanite binder from Sigma-Aldrich, after which stirring is repeated for 30 seconds with an axial stirrer at 750 revolutions per minute. The heat flow is recorded with a TAM Air calorimeter (TA Instruments).

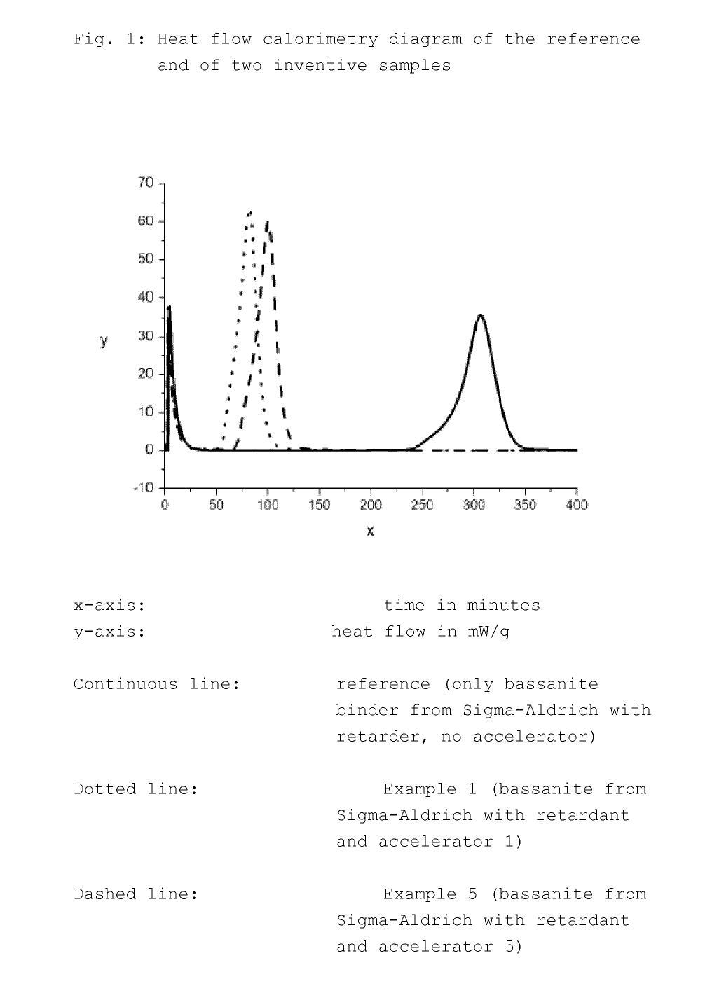

The FIG. 1 drawing shows, for example, a number of heat flow curves (reference and hardening accelerator samples 1 and 5). The reference (blank value) is the sample produced by the method specified above, from the bassanite binder and the above-stated retarder, without the addition of accelerator.

The performance of the accelerators is characterized by the acceleration factor aₜ, and is summarized in Table 3.

The acceleration factor aₜ is calculated from the shift in the time t of the maximum heat flow. In Example 1, the heat flow maximum is shifted from 307 min without accelerator (=t_{blank}) to 100 min (Example 1=tₛₐₘₚₗₑ), from which the acceleration factor aₜ is calculated as follows:

$${a}_{t} = \frac{{t}_{blank} - {t}_{sample}}{{t}_{blank}}$$

For Example 1 of Tables 2 and 3 (and shown in FIG. 1), therefore:

$${a}_{t} = \frac{307 min - 100 min}{307 min} = 0.67 = 67 \%$$

TABLE 3
Relative acceleration of the hardening accelerators

| | Relative |
|---|---|
| | acceleration aₜ |
| Ex. No. | (%) |
| Reference¹⁾ | 0 |
| Comparative 1²⁾ | 51 |
| Comparative 2²⁾ | 39 |
| 1 | 67 |
| 2 | 62 |
| 3 | 64 |
| 4 | 69 |
| 5 | 72 |
| 6 | 63 |
| 7 | 61 |
| 8 | 51 |

¹⁾Bassanite from Sigma-Aldrich, with retarder, without accelerator
²⁾Comparative Example 1 and Comparative Example 2 are standard accelerators based on ground calcium sulphate dihydrate.

The relative accelerators in Table 3 show that in all cases the hardening was accelerated effectively. Relative to the standard pulverulent accelerators, the results achievable were in most cases much better, or of similar quality.

1. A method for producing a pulverulent CaSO₄-based hardening accelerator, the method comprising:
a) contacting, at a spray nozzle, an aqueous phase I comprising liquid calcium ions and an aqueous phase H comprising liquid sulphate ions, the molar ratio of the calcium ions in phase I to the sulphate ions in phase II being from 1/5 to 5/1, and
b) spraying phases I and II from said contacting with one another at the spray nozzle into a streaming environment of drying gas with an entry temperature in the range from 120 to 300° C. and an exit temperature in the range from 60 to 120° C., wherein
the calcium ions react with the sulphate ions and, with removal of water by the carrier gas, the pulverulent hardening accelerator is obtained.

2. The method according to claim 1, wherein the spray nozzle is a multi-channel nozzle.

3. The method according to claim 2, wherein
the multi-channel nozzle comprises at least two channels,
the aqueous phase I comprising liquid calcium ions and the aqueous phase II comprising liquid sulphate ions are supplied separately into at least two of the channels, and
phases I and II are contacted with one another at an outlet of the channels of the nozzle during said contacting.

4. The method according to claim 1,
wherein phase I comprises an aqueous solution of a calcium salt,
wherein phase II comprises an aqueous solution of a sulphate salt or of a sulphate ion-forming acid, and
wherein the solubility of the calcium salt in the aqueous phase I is greater than 0.1 mol/l and the solubility of the sulphate salt or of the sulphate ion-forming acid in the aqueous phase II is greater than 0.1 mol/l, all solubilities being based on the temperature of 20° C. and atmospheric pressure.

5. The method according to claim 1, wherein
a concentration of the calcium ions in phase I is from 0.1 mol/l to 3.5 mol/l, and
a concentration of the sulphate ions in phase II is from 0.1 mol/l to 3.5 mol/l.

6. The method according to claim 4, wherein
the calcium salt comprises at least one salt selected from the group consisting of calcium acetate, calcium formate, calcium chloride, calcium bromide, calcium iodide, calcium hydroxide, calcium sulphamidate, calcium lactate, calcium methanesulphonate, calcium propionate, calcium nitrate, and calcium carbonate.

7. The method according to claim 4, wherein
the sulphate salt comprises at least one salt selected from the group consisting of an alkali metal sulphate, ammonium sulphate, aluminium sulphate, and magnesium sulphate, or
the sulphate ion-forming acid comprises sulphuric acid.

8. The method according to claim 1, wherein
the spraying of phases I and II produces droplets having an average drop size of 5 to 2000 μm.

9. The method according to claim 1, wherein
one or both of phases I and II comprises a polymer that comprises at least one acid group, or a salt of said polymer, said polymer or said salt of said polymer having an average molecular weight M_{w} of 5000 g/mol to 100 000 g/mol.

10. The method according to claim 9, wherein each of said at least one acid group is an acid group selected from the group consisting of a carboxyl group, a phosphono group, a sulphino group, a sulpho group, a sulphamido group, a sulphoxy group, a sulphoalkyloxy group, a sulphinoalkyloxy group, and a phosphonooxy group.

11. The method according to claim 9, wherein the polymer comprises polyether groups.

12. The method according to claim 11,
wherein each polyether group is represented by structural unit (I),
*—U—(C(O))ₖ—X-(AlkO)ₙ—W (I)
wherein
* indicates the location of bonding to the polymer,
U is a chemical bond or an alkylene group having 1 to 8 C atoms,
X is oxygen or a group NR¹,
k is 0 or 1,
n is an integer where the average value thereof, based on the polymer, is in the range from 3 to 300,
Alk is an alkylene group that can be identical or different within the group (Alk-O)ₙ,
W is a hydrogen atom, an alkyl radical, or an aryl radical, or W denotes the group Y—F, where
Y is a linear or branched alkylene group having 2 to 8 C atoms and may carry a phenyl ring,
F is a 5- to 10-membered nitrogen heterocycle which is bonded via nitrogen and which as ring members, besides the nitrogen atom and besides carbon atoms, may have 1, 2 or 3 additional heteroatoms, selected from the group consisting of oxygen, nitrogen and sulphur, it being possible for the nitrogen ring members to have a group R², and it being possible for 1 or 2 carbon ring members to be present in the form of carbonyl group,
R¹ is hydrogen, C₁-C₄ alkyl or benzyl, and
R² is hydrogen, C₁-C₄ alkyl or benzyl.

13. The method according to claim 12, wherein the polymer is a polycondensation product comprising:
(II) a structural unit comprising an aromatic or heteroaromatic group and a polyether group of the structural unit and
(III) a phosphated structural unit comprising an aromatic or heteroaromatic group.

14. The method according to claim 13, wherein structural units (II) and (III) are obtained by copolymerization of monomers which are represented by general formulae (IIa) and (III), respectively:
A-U—(C(O))ₖ—X-(AlkO)ₙ—W (IIa)
wherein
each A is identical or different and represents a substituted or unsubstituted aromatic or heteroaromatic compound having 5 to 10 C atoms in the aromatic system, the further radicals possessing the definition stated above for structural unit (I), and 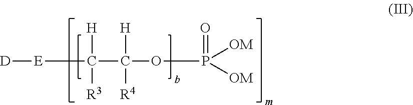
wherein
each D is identical or different and represents a substituted or unsubstituted aromatic or heteroaromatic compound having 5 to 10 C atoms in the aromatic system,
each E is identical or different and represents N, NH or O,
m=2 if E=N, and m=1 if E=NH or O,
each R³ and R⁴ is independently, a branched or unbranched C₁ to C₁₀ alkyl radical, C₅ to C₈cycloalkyl radical, aryl radical, heteroaryl radical or H,
each b is identical or different and represents an integer from 0 to 300, and
M represents H or one cation equivalent.

15. The method according to claim 13, wherein the polycondensation product further comprises a structural unit (IV) which is represented by formula (IV): 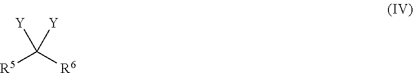
wherein
each Y, independently, represents a group of (II), (III) or other constituents of the polycondensation product; and
R⁵ and R⁶ are identical or different and represent H, CH₃, COOH or a substituted or unsubstituted aromatic or heteroaromatic compound having 5 to 10 C atoms.

16. The method according to claim 12,
wherein the polymer comprises at least one copolymer comprising monomer units from of a mixture of monomers comprising:
(V) at least one ethylenically unsaturated monomer which comprises at least one radical selected from the group consisting of carboxylic acid, carboxylic salt, carboxylic ester, carboxylic amide, carboxylic anhydride and carboxylic imide, and
(VI) at least one ethylenically unsaturated monomer having a polyether group of the structural unit (I).

17. The method according to claim 16, wherein each ethylenically unsaturated monomer (V) is represented by one of general formulae (Va), (Vb) and (Vc): 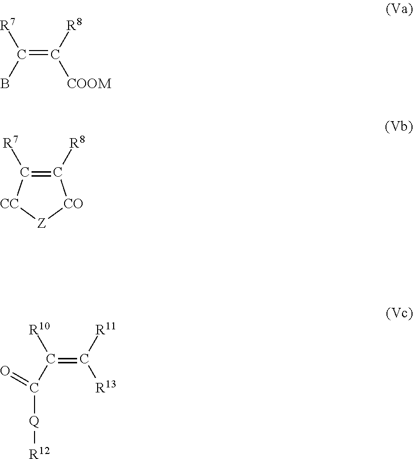
wherein
R⁷ and R⁸ independently of one another are hydrogen or an aliphatic hydrocarbon radical having 1 to 20 C atoms,
B is H, —COOM, —CO—O(C_{q}H_{2q}O)ᵣ—R⁹ or —CO—NH—(CₐH_{2q}O)ᵣ—R⁹,
M is H or one cation equivalent,
R⁹ is hydrogen, an aliphatic hydrocarbon radical having 1 to 20 C atoms, a cycloaliphatic hydrocarbon radical having 5 to 8 C atoms, or an optionally substituted aryl radical having 6 to 14 C atoms,
q independently at each occurrence for each (C_{q}H₂O) unit is identical or different and is 2, 3 or 4 and
r is 0 to 200,
Z is O or NR³;
R¹⁰ and R¹¹ independently of one another being hydrogen or an aliphatic hydrocarbon radical having 1 to 20 C atoms, a cycloaliphatic hydrocarbon radical having 5 to 8 C atoms, or an optionally substituted aryl radical having 6 to 14 C atoms,
R¹² being identical or different and also represented by (CₙH₂ₙ)—SO₃M with n=0, 1, 2, 3 or 4, (CₙH₂ₙ)—OH with n=0, 1, 2, 3 or 4; (CₙH₂ₙ)—PO₃M₂ with n=0, 1, 2, 3 or 4, (CₙH₂ₙ)—OPO₃M₂ with n=0, 1, 2, 3 or 4, (C₆H₄)—SO₃M, (C₆H₄)—PO₃M₂, (C₆H₄)—OPO₃M₂ and (CₙH₂ₙ)—NR¹⁴_{b} with n=0, 1, 2, 3 or 4 and b=2 or 3,
R¹³ being H, —COOM, —CO—O(C_{q}H_{2q}O)ᵣ—R⁹ or —CO—NH—(C_{q}H_{2q}O)ᵣ—R⁹, where M, R⁹, q and r possess definitions stated above,
R¹⁴ being hydrogen, an aliphatic hydrocarbon radical having 1 to 10 C atoms, a cycloaliphatic hydrocarbon radical having 5 to 8 C atoms, or an optionally substituted aryl radical having 6 to 14 C atoms, and
Q being identical or different and also represented by NH, NR¹⁵ or O; where R¹⁵ is an aliphatic hydrocarbon radical having 1 to 10 C atoms, a cycloaliphatic hydrocarbon radical having 5 to 8 C atoms, or an optionally substituted aryl radical having 6 to 14 C atoms.

18. The method according to claim 17, wherein the ethylenically unsaturated monomer (VI) is represented by the following general formula (VI): 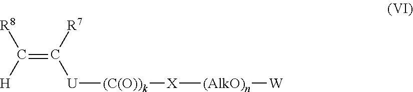
in which
all radicals have the definitions stated above.

19. A pulverulent hardening accelerator produced by the method according to claim 1,
wherein the crystallite size of bassanite present in the hardening accelerator is from 1 to 45 nm,
the crystallite size of the bassanite determined by X-ray diffraction with subsequent Rietveld analysis of the pulverulent hardening accelerator.

20-22. (canceled)

23. A method of hardening basanite or anhydrite, comprising:
mixing bassanite or anhydrite and a pulverulent hardening accelerator according to claim 19, and
hardening bassanite or anhydrite in the presence of the pulverulent hardening accelerator.

24. A method of forming a gypsum plasterboard panel, comprising:
mixing a gypsum slurry that comprises bassanite, water, and a pulverulent hardening accelerator according to claim 19,
depositing the gypsum slurry between at least two cardboard sheets to form a plasterboard panel, and
hardening the gypsum slurry.

25. A method of forming a self-leveling screed, comprising:
mixing bassanite or anhydrite and a pulverulent hardening accelerator according to claim 19 to form a self-leveling screed.

26. The method according to claim 25, further comprising:
hardening the self-leveling screed.
